(19) United States
(12) Patent Application Publication
(10) Pub. No.: US 2025/0163739 A1
(43) Pub. Date: May 22, 2025

(54) MUTE HINGE

(71) Applicant: Yu ZHOU, Hangzhou (CN)

(72) Inventor: Yu ZHOU, Hangzhou (CN)

(21) Appl. No.: 18/513,403

(22) Filed: Nov. 17, 2023

(51) Int. Cl. E05D 5/14; E05D 3/02; E05D 5/12

(52) U.S. Cl. CPC E05D 5/14; E05D 3/02; E05D 5/12

(57) ABSTRACT

A mute hinge is provided with two fixing leaves, a pin, and at least one plastic element. Each one of the fixing leaves has at least one knuckle. The pin is mounted through the at least one knuckle of each one of the fixing leaves. The at least one plastic element encloses the pin and is located between the pin and the at least one knuckle of the fixing leaves. Therefore, the mute hinge makes no noise since the plastic element is mounted between the pin and the knuckles of the fixing leaves, and thus the knuckles of the fixing leaves may not contact and rub the pin.

### BACKGROUND OF THE INVENTION

### 1. Field of the Invention

The present invention relates to a hardware part, especially to a hinge that may not make noises.

### 2. Description of the Prior Arts

A hardware part, hinge, is conventionally made of metal. Since metal has high stiffness, the elements of a hinge may collide and rub each other when the hinge is pivoted. Therefore, the hinge may make noises.

To reduce the noises, the user may apply damping grease and lubricating oil on the hinge. Precisely, apply the damping grease and the lubricating oil in the gaps between the elements of the hinge. However, the damping grease and lubricating oil always leak and then stain the environmental elements, e.g. the door frame, etc. Besides, the stained elements are very hard to clean. Moreover, after the damping grease and the lubricating oil leak out or become dry, the metal elements of the hinge collide and rub each other again. In other words, the damping grease and the lubricating oil can only maintain for a short period.

To overcome the shortcomings, the present invention provides a mute hinge to mitigate or obviate the aforementioned problems.

### SUMMARY OF THE INVENTION

The main objective of the present invention is to provide a mute hinge that reduces contact between hardware parts.

The mute hinge has two fixing leaves, a pin, and at least one plastic element. Each one of the fixing leaves has at least one knuckle. The pin is mounted through the at least one knuckle of each one of the fixing leaves. The at least one plastic element encloses the pin and is located between the pin and the at least one knuckle of the fixing leaves.

As a result, the mute hinge makes no noise since the plastic element is mounted between the pin and the knuckles of the fixing leaves. Therefore, when the mute hinge is working, i.e. the fixing leaves pivot with respect to each other about the pin and the plastic element, the knuckles of the fixing leaves may not contact and rub the pin and thus the noise is reduced. Further, the useful lifetime of the plastic element is larger than the time drying the damping grease and the lubricating oil, so the present mute hinge maintains a longer silent time. Besides, the present mute hinge may not need the damping grease and the lubricating oil, which avoids leaking and staining the environment; or, during assembly, the user's hand can keep clean.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a mute hinge in accordance with a first embodiment of the present invention;

FIG. 2 is an exploded view of the mute hinge in FIG. 1;

FIG. 3 is a side view of a pin and a plastic element of the mute hinge in FIG. 1;

FIG. 4 is a side view of the pin of the mute hinge in FIG. 3;

FIG. 5 is a side view of the plastic element of the mute hinge in FIG. 3;

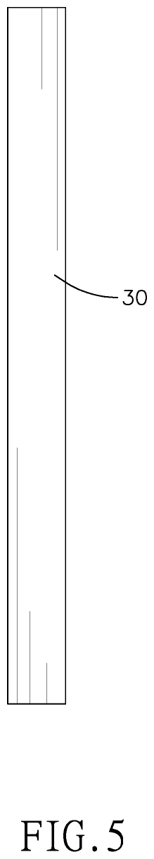

FIG. 6 is a side view of a pin and a plastic element in accordance with another embodiment of the present invention;

FIG. 7 is a perspective view of a pin and a plastic element in accordance with a second embodiment of the present invention;

FIG. 8 is a perspective view of a pin and a plastic element in accordance with a third embodiment of the present invention; and

FIG. 9 is a side view of the pin and the plastic element of the mute hinge in FIG. 8.

### DETAILED DESCRIPTION OF THE PREFERRED EMBODIMENTS

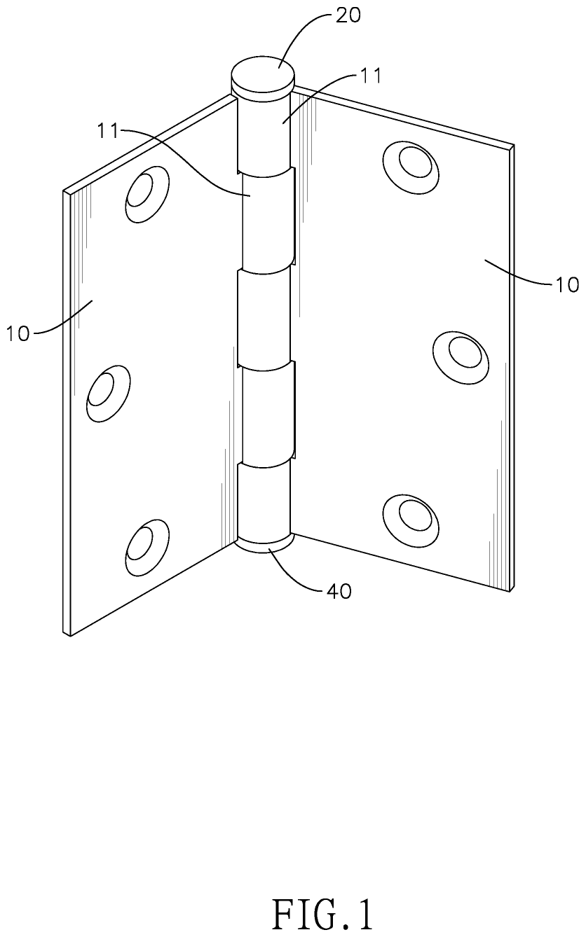

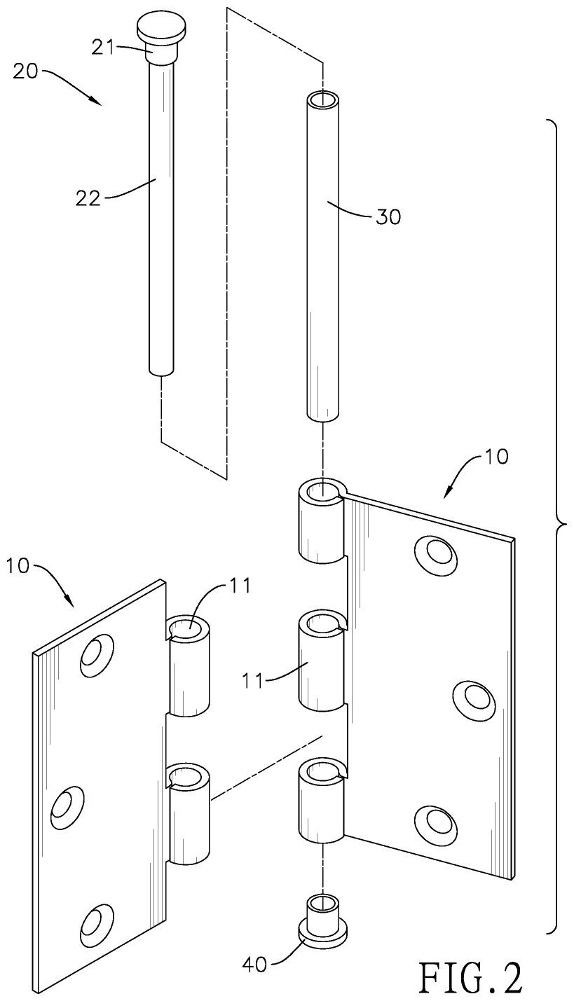

Please refer to FIG. 1 and FIG. 2. A mute hinge in accordance with the present invention is provided. The mute hinge comprises two fixing leaves 10, a pin 20, and at least one plastic element 30. The leaves 10 and the pin 20 may be made of metal. Each one of the fixing leaves 10 has at least one knuckle 11 and the pin 20 is mounted through the at least one knuckle 11 of each one of the fixing leaves 10. Since the plastic element 30 encloses the pin 20 and is located between the pin 20 and the knuckles 11 of the fixing leaves 10, the pin 20 does not contact the knuckles 11.

In the first embodiment, the mute hinge further has a cap 40. The cap 40 is mounted at an end of the pin 20 and thereby the knuckle 11 of each one of the fixing leaves 10 is clamped by the cap 40 and the pin 20. Precisely, the dimensions of the largest portion of the cap 40 and the largest portion of the pin 20 are larger than inner diameters of the knuckle 11 of each one of the fixing leaves 10, so when the cap 40 is fixed on the pin 20, the knuckle 11 of each one of the fixing leaves 10 is clamped.

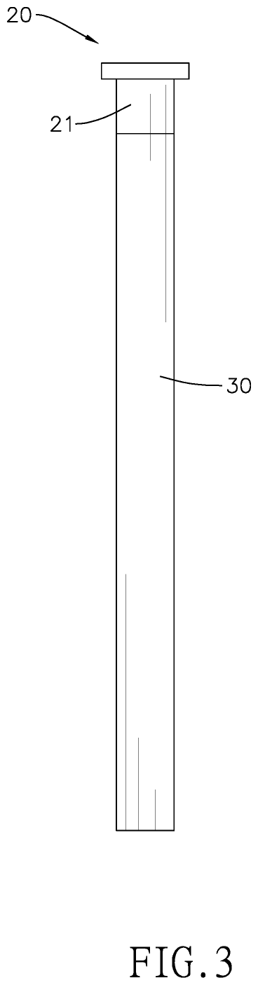

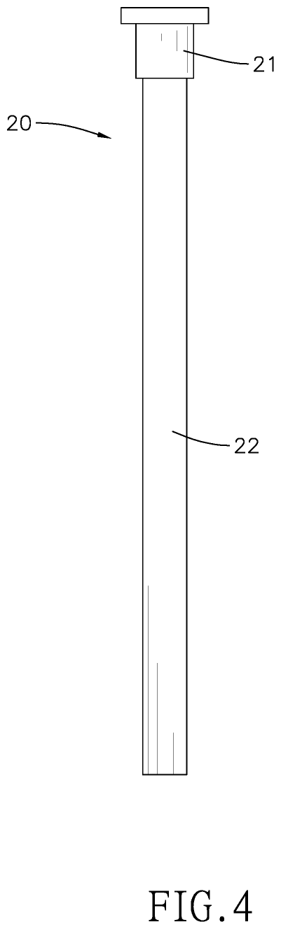

Please also refer to FIG. 3 and FIG. 4. In the first embodiment, the pin 20 includes one large section 21 and one small section 22. The small section 22 includes two ends opposite to each other. The large section 21 is connected at one of the ends of the small section 22 and the cap 40 mounted at the other one of the ends of the small section 22. In other words, the small section 22 is located between the large section 21 and the cap 40. A diameter of the large section is larger than a diameter of the small section 22.

Correspondingly, in the first embodiment, the at least one plastic element 30 is one said plastic element 30. The plastic element 30 is mounted on and encloses the small section 22 of the pin 20. An outer diameter of the plastic element 30 is slightly larger than or equal to the diameter of the large section 21. In other words, the outer surface of the plastic element 30 is configured to contact the knuckles 11 of the fixing leaves 10, such that the pin 20 will not collide and rub the knuckle 11 of the fixing leaves 10.

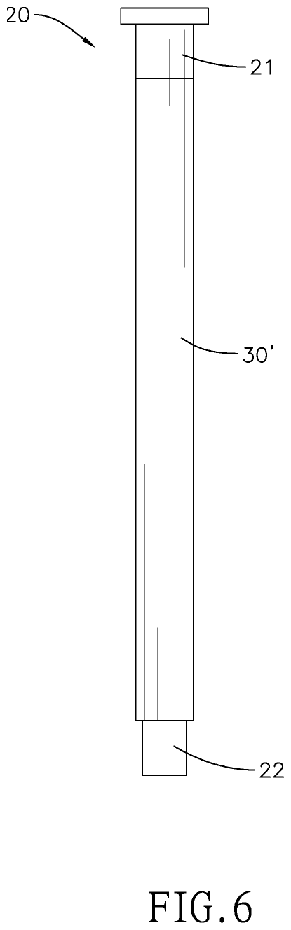

Precisely, the plastic element 30 is a hollow cylinder and the pin 20 is sleeved in the hollow cylinder. A length of the hollow cylinder is equal to a length of the small section 22. In other words, the entire small section 22 is covered by the plastic element 30. However, it is not limited thereto; as shown in FIG. 6, the length of the plastic element 30′ is slightly smaller than the pin 20. In the first embodiment, the outer surface of the hollow cylinder is a complete cylindrical surface without any groove, hole, notch, etc.

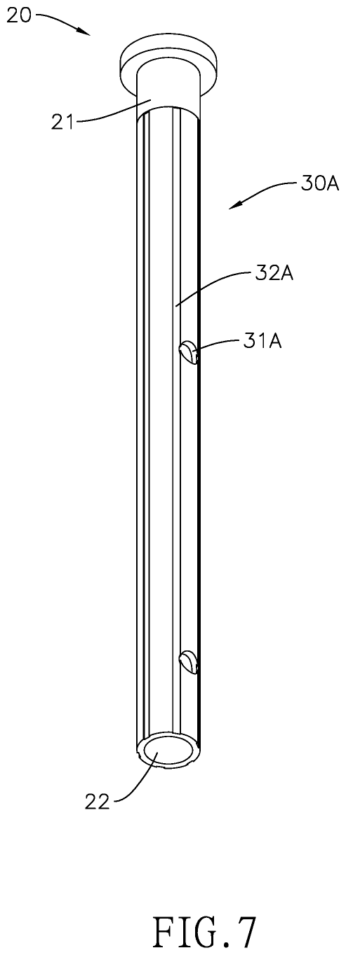

Please refer to FIG. 7. A second embodiment of the mute hinge is provided. The second embodiment is similar to the first embodiment, but the only difference is that, in the second embodiment, the plastic element 30A is also a hollow cylinder but has at least one through hole 31A and at least one groove 32A. In this embodiment, the at least one through hole 31A includes multiple said through holes 31A such that the pin 20 is exposed via the through holes 31A.

The at least one groove 32A may include multiple grooves 32A. The grooves 32A may be concaved on the outer surface of the hollow cylinder, but it is not limited thereto. In this embodiment, the multiple grooves 32A may extend along a longitudinal direction of the pin 20, a circumferential direction of the pin 20, or a spiral direction with respect to the pin 20. In another embodiment, the hollow cylinder may have only one groove 32A extending in the spiral direction with respect to the pin 20.

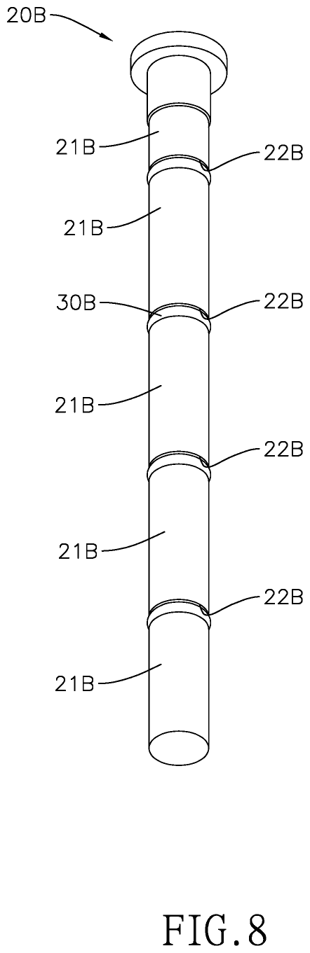

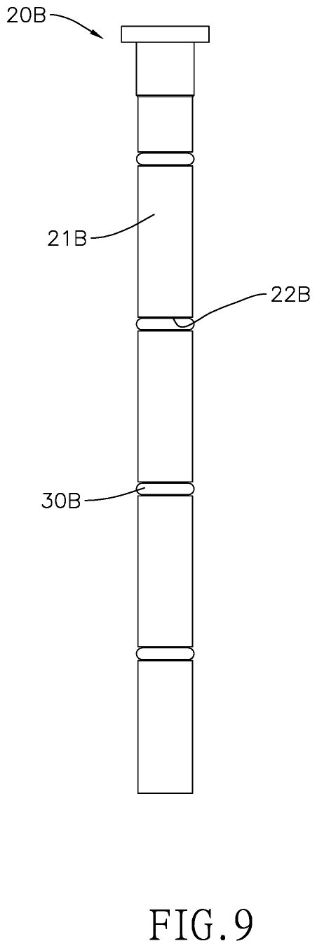

Then please refer to FIG. 8 and FIG. 9. A third embodiment of the mute hinge is provided. The third embodiment is similar to the first embodiment, but the only difference is that, in the third embodiment, the pin 20B includes multiple said large sections 21B and multiple said small sections 22B and the at least one plastic element 30B includes multiple said plastic elements 30B. Further, the large sections 21B and the small sections 22B are arranged staggered

Each one of the plastic elements 30B is ring-shaped and thus each one of the plastic elements 30B encloses one of the small sections 22B. Like the first embodiment, outer diameters of the plastic elements 30B are slightly larger than or equal to the diameter of the large sections 21B such that the plastic elements 30B can contact the knuckles 11.

In this embodiment, a distance between the adjacent two of the large sections 21B equals a distance of each small section 22B, and further equals a thickness of each plastic element 30B. In other words, each one of the plastic elements 30B is clamped by each two of the adjacent large sections 21B.

Consequently, with such structures, after assembled, the mute hinge makes no noise since the plastic element(s) 30 is mounted between the pin 20 and the knuckles 11 of the fixing leaves 10. Therefore, when the mute hinge is working, i.e. when the fixing leaves 10 pivot with respect to each other about the pin 20 and the plastic element(s) 30, the knuckles 11 of the fixing leaves 10 may not contact and rub the pin 20 and thus the noise is reduced. Further, the useful lifetime of the plastic element(s) 30 is larger than the time drying the damping grease and the lubricating oil, so the present mute hinge maintains a longer silent time. Besides, the present mute hinges may not use the damping grease and the lubricating oil, which avoids leaking and staining the environment; or, during assembly, the user's hands can keep clean.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

1. A mute hinge comprising:
two fixing leaves; each one of the fixing leaves including:
at least one knuckle;
a pin mounted through the at least one knuckle of each one of the fixing leaves; and
at least one plastic element enclosing the pin and located between the pin and the at least one knuckle of the fixing leaves; wherein the at least one plastic element is a hollow cylinder and the pin is sleeved in the hollow cylinder, and the hollow cylinder has:
an outer surface configured to contact the at least one knuckle of the fixing leaves;
at least one groove being a narrowed recess and formed on the outer surface; the at least one groove extending along a longitudinal direction of the pin, a circumferential direction of the pin, or a spiral direction with respect to the pin; and
at least one through hole extending in a radial direction with respect to the pin, the pin exposed via the at least one through hole.

2. The mute hinge as claimed in claim 1 further comprising:
a cap mounted at an end of the pin and thereby the at least one knuckle of each one of the fixing leaves clamped by the cap and the pin.

3. The mute hinge as claimed in claim 1, wherein:
the pin includes:
a large section and a small section, a diameter of the large section being larger than a diameter of the small section; the small section including two ends opposite to each other, the large section connected at one of the ends of the small section;
the least one plastic element enclosing the small section of the pin; an outer diameter of the at least one plastic element is larger than or equal to the diameter of the large section.

4. The mute hinge as claimed in claim 2, wherein:
the pin includes:
a large section and a small section, a diameter of the large section being larger than a diameter of the small section; the small section including two ends opposite to each other, the large section connected at one of the ends of the small section and the cap mounted at the other one of the ends of the small section;
the least one plastic element enclosing the small section of the pin; an outer diameter of the at least one plastic element is larger than or equal to the diameter of the large section.

5. (canceled)

6. (canceled)

7. The mute hinge as claimed in claim 1, wherein a length of the hollow cylinder is equal to a length of the small section.

8. The mute hinge as claimed in claim 4, wherein a length of the hollow cylinder is equal to a length of the small section.

9. (canceled)

10. (canceled)

11. (canceled)

12. (canceled)

13. The mute hinge as claimed in claim 1, wherein:
the pin includes:
a plurality of the large sections and a plurality of the small sections, a diameter of each one of the large sections being larger than a diameter of each one of the small sections; the large sections and the small sections are arranged staggered;
the at least one plastic element includes multiple said plastic elements, and each one of the plastic elements encloses one of the small sections; an outer diameter of the at least one plastic element is larger than or equal to the diameter of the large section.

14. The mute hinge as claimed in claim 2 wherein:
the pin includes:
a plurality of the large sections and a plurality of the small sections, a diameter of each one of the large sections being larger than a diameter of each one of the small sections; the large sections and the small sections are arranged staggered;
the at least one plastic element includes multiple said plastic elements, and each one of the plastic elements encloses one of the small sections; an outer diameter of the at least one plastic element is larger than or equal to the diameter of the large section.

15. The mute hinge as claimed in claim 13, wherein each one of the plastic elements is clamped by each adjacent two of the large sections.

16. The mute hinge as claimed in claim 14, wherein each one of the plastic elements is clamped by each adjacent two of the large sections.

17. (canceled)

18. (canceled)
